(19) United States
(12) Patent Application Publication
(10) Pub. No.: US 2026/0048526 A1
(43) Pub. Date: Feb. 19, 2026

(54) METHOD FOR ADAPTING A PRESSING FORCE OF A GRANULATING MACHINE, COMPUTER PROGRAM PRODUCT, CONTROLLER, GRANULATING MACHINE, AND METHOD FOR GRANULATING MATERIAL STRANDS

(71) Applicant: Coperion GmbH, Stuttgart (DE)

(72) Inventors: Mareike TABELING, Stuttgart (DE); Arne ADLER, Stuttgart (DE); Moritz WOLFF, Ludwigsburg (DE); Tomi TRATNIK, Ditzingen (DE); Michael HAMMER, Tübingen (DE); Jonas RÖHLING, Stuttgart (DE); Jürgen BARTL, Göppingen (DE)

(73) Assignee: Coperion GmbH, Stuttgart (DE)

(21) Appl. No.: 18/714,785

(22) PCT Filed: Nov. 30, 2022
(86) PCT No.: PCT/EP2022/083836

§ 371 Date: Jun. 20, 2025

(30) Foreign Application Priority Data
Dec. 2, 2021 (EP) 21212057.0

(51) Int. Cl. B29B 9/06; B29C 48/04; B29C 48/92

(52) U.S. Cl. CPC B29B 9/065; B29C 48/04; B29C 48/92; B29C 2948/92019; B29C 2948/92028; B29C 2948/92095; B29C 2948/92514

(57) ABSTRACT

A method for adapting a pressing force of at least one blade of a granulating machine for granulating material strands, such as plastic material strands. The granulating machine has a force generating means for pushing the at least one blade with the pressing force against a perforated plate of the granulating machine. The method includes the steps of specifying a blade pressing force; determining a hydrodynamic force, such as axial pressure force, which is generated by rotation of the at least one blade and acts on the at least one blade towards the perforated plate; determining the pressing force on the basis of the specified blade pressing force and the determined hydrodynamic force; and providing the determined pressing force to adapt the pressing force prevailing in the granulating machine. Also disclosed are a corresponding computer program product, a controller, a granulating machine, and a method for granulating material strands.

### CROSS-REFERENCE TO RELATED APPLICATION

This application is a 35 U.S.C. § 371 national stage patent application of International Patent Application No. PCT/EP2022/083836 filed Nov. 30, 2022, which claims priority to European Patent Application No. EP 21212057.0, filed on Dec. 2, 2021, the entire contents of which are hereby incorporated by reference.

### DESCRIPTION

The disclosure relates to a method for adapting a pressing force of at least one blade of a granulating machine for granulating material strands, such as plastic material strands. The disclosure also relates to a corresponding computer program product, a controller and a granulating machine. The disclosure also relates to a method for granulating material strands.

Document DE 103 22 610 A1 describes a granulating machine that has a perforated plate and a blade head. The blade head has a plurality of granulating blades that lie against the perforated plate on a downstream side and are driven in rotation by means of a drive motor, so that material strands passing through the perforated plate are cut into granules. The granulating blades are necessarily pressed against the perforated plate with a pressing force.

The position of the granulating blades in relation to the perforated plate and the level of pressing force, in particular the contact pressure of the granulating blades, must be set precisely to achieve a high cutting quality and to minimize wear. If the pressing force or contact pressure is too high, the granulating blades are worn down too much and the wear on the perforated plate increases. If the pressing force or contact pressure is too low, a lubricating film can form on the perforated plate, and thereby significantly reduce the required granule quality until the machine has to be switched off if the quality is too poor. Thus, the quality of the granules is a function of the correct selection of cutting parameters for the granulating machine.

Typically, the pressing force or contact pressure is set manually and then left constant during operation. The problem is that individual process parameters can change during operation. The manual setting means that it is not possible to react automatically to these changes. Lack of adaptation or operating errors during operation can lead to damage to the granulating blades and perforated plate along with fluctuations in the granule quality.

Embodiments of the disclosure are based on the object of functionally improving a method mentioned at the beginning for adapting a pressing force. In addition, Embodiments of the disclosure are based on the object of structurally and/or functionally improving a computer program product mentioned at the beginning, a controller mentioned at the beginning and a granulating machine mentioned at the beginning. Furthermore, Embodiments of the disclosure are based on the object of functionally improving a method for granulating material strands mentioned at the beginning.

Therefore, it is in particular an object of embodiments of the present disclosure to provide a method for adapting the pressing force and a granulating machine that can reduce or eliminate the problems shown in connection with the prior art.

The object is achieved by a method having the features of claim 1. In addition, the object is achieved with a computer program product having the features of claim 14 and with a controller having the features of claim 15. Furthermore, the object is achieved with a granulating machine having the features of claim 16 and with a method having the features of claim 18. Advantageous embodiments and/or developments are the subject matter of the dependent claims.

A method can be and/or can be used to adapt a pressing force of at least one blade of a granulating machine. The granulating machine can be designed and/or intended for granulating material strands, such as plastic material strands. The granulating machine can be an underwater granulating machine. The granulating machine can have a perforated plate. The at least one blade can be a granulating blade. The granulating machine can have a plurality of blades, such as granulating blades. The granulating machine can have a force generation device. The force generation device can be designed to generate and/or provide the pressing force and/or a contact pressure. The force generation device can be designed for pushing the at least one blade with the pressing force and/or the contact pressure against the perforated plate of the granulating machine. The force generation device can be a hydraulic device, such as a hydraulic system, a pneumatic device, such as a pneumatic system, a hydro-pneumatic device, an electronic device, a mechanical device or an electro-mechanical device. The force generation device can have a drive, for example a hydraulic, pneumatic, hydro-pneumatic, electronic or electro-mechanical drive, such as a linear drive or a servo drive. The hydraulic device can be a hydraulic aggregate and/or a hydraulic pressure aggregate and/or a hydraulic pressure unit. The hydraulic device can have at least one piston. The at least one piston can be displaceably mounted in a cylinder. The at least one piston can be acted upon and/or displaced by means of a hydraulic fluid. The hydraulic device can be controlled in such a way that the pressing force and/or a contact pressure is set and/or that the at least one blade is pressed against the perforated plate with the pressing force and/or the contact pressure. The at least one piston can be displaced, in particular to achieve the pressing force and/or the contact pressure.

The method may comprise the step: Specifying a blade pressing force. The blade pressing force can or will be specified as a target value. The blade pressing force and/or the target value of the blade pressing force can depend on the properties and/or number of blades and/or on the properties of the material to be granulated and/or on further process parameters. The properties of the blades can comprise the material properties of the blades and/or the degree of sharpening and/or the angle of attack of the blades.

The method may comprise the step: Determining the pressing force on the basis of the specified blade pressing force and/or a hydrodynamic force, for example.

The method may comprise the step: Providing the determined pressing force for adapting the pressing force prevailing in the granulating machine.

The pressing force can be a contact pressure force and/or a hydraulic force, such as hydraulic force. The pressing force can be the difference between a forward force, for example an axial forward force, and a backward force, for example an axial backward force. The force generation device can be designed to generate and/or provide the forward force and/or backward force.

The method may comprise the step: Providing at least one parameter, for example hydraulic parameters, of the force generation device, for example a hydraulic device. The method may comprise the step: Calculating a pressure, such as a contact pressure and/or a hydraulic pressure, on the basis of the provided and/or determined pressing force and/or the provided at least one parameter, such as a hydraulic parameter, of the force generation device. The method may comprise the step: Providing the calculated pressure, such as a contact pressure and/or a hydraulic pressure, in particular as a new target value, for adapting the pressure prevailing in the granulating machine (100), such as a contact pressure and/or a hydraulic pressure. The calculated pressure, such as a contact pressure and/or a hydraulic pressure, can be a target value, such as a target pressure and/or a target contact pressure and/or a target hydraulic pressure. The calculated pressure, such as a contact pressure and/or a hydraulic pressure, can be, for example, an axial forward pressure of the force generation device, in particular the hydraulic device. The calculated pressure can be a target forward pressure of the force generation device, in particular the hydraulic device. The at least one parameter, such as a hydraulic parameter, can be a first surface, for example a piston surface and/or a total piston surface, of the force generation device, in particular the hydraulic device, assigned to the calculated pressure, such as a contact pressure and/or a hydraulic pressure. The at least one parameter, such as a hydraulic parameter, can be, for example, an axial backward pressure of the force generation device, in particular the hydraulic device. The at least one parameter, such as a hydraulic parameter, can be a second surface assigned to the backward pressure, such as a piston surface and/or a total piston surface, of the force generation device, in particular the hydraulic device. The force generation device, in particular the hydraulic device, can have a plurality of, for example two, three or more pistons and/or associated cylinders. The total piston surface can be the sum of all piston surfaces. Piston surface can be understood as the cross-sectional surface of the piston. The pressing force can be the result and/or the sum of all forces acting on the piston surface and/or total piston surface, for example a forward force and/or a backward force, and/or pressures, for example a forward pressure and/or a backward pressure. A contact pressure can be defined by the pressing force. For example, this contact pressure can be the differential pressure between forward and backward pressure. The forward force can be defined and/or calculated by the forward pressure and/or by the surface assigned to the forward pressure, such as a piston surface and/or a total piston surface. The backward force can be defined and/or calculated by the backward pressure and/or by the surface assigned to the backward pressure, such as a piston surface and/or a total piston surface.

Unless otherwise stated or unless otherwise apparent from the context, the term “axial” refers to a direction of extension of an axis of rotation of the at least one blade and/or a blade head and/or a direction of movement of the at least one actuator, such as a piston, of the force generation device, in particular the hydraulic device. Unless otherwise stated or unless otherwise apparent from the context, the indications “forward” and “backward” refer to a direction along the axis of rotation or direction of movement. “Forward” can then correspond to a direction, for example the direction in which the at least one blade moves towards the perforated plate. “Backward” can then correspond to a direction away from the perforated plate, for example a direction opposite to the forward direction.

The backward pressure can be detected by sensors. The backward pressure can be a detected actual value. The first surface assigned to the pressure, such as a contact pressure and/or a hydraulic pressure, in particular a forward pressure, can or will be specified. The first surface assigned to the pressure, such as a contact pressure and/or a hydraulic pressure, in particular a forward pressure, can be a variable which is a function of the size of the granulating machine and/or the at least one actuator and/or piston, such as a surface and/or a cross-sectional surface. The second surface assigned to the backward pressure can or will be specified. The second surface assigned to the backward pressure can be a variable which is a function of the size of the granulating machine and/or the at least one actuator and/or piston, such as a surface and/or a cross-sectional surface.

The pressure, such as a contact pressure and/or a hydraulic pressure, in particular a forward pressure, can be calculated on the basis of the first surface assigned to the pressure, such as a contact pressure and/or a hydraulic pressure, in particular a forward pressure, and/or the backward pressure and/or the second surface assigned to the backward pressure. The product of the backward pressure with the second surface assigned to the backward pressure can be formed or calculated.

The method may comprise the step: Determining a hydrodynamic force, for example an axial pressure force. The hydrodynamic force can or will be generated by rotation of the at least one blade. The hydrodynamic force can act on the at least one blade in the direction of the perforated plate, for example in the forward direction.

The hydrodynamic force can or will be calculated or detected by sensors. The hydrodynamic force can or will be calculated and/or estimated and/or determined on the basis of a rotational speed, for example a blade rotational speed and/or a blade head rotational speed.

The rotational speed can or will be detected by sensors, for example as an actual value, such as an actual rotational speed. The rotational speed can or will be specified as a target value, such as a target rotational speed. A rotational speed can or will be detected by sensors as an actual value or a rotational speed can or will be specified as a target value. Initially, a rotational speed can or will be specified as a target value and then a rotational speed that is thereupon set can or will be detected by sensors as an actual value. The hydrodynamic force can or will be calculated and/or estimated and/or determined on the basis of the actual rotational speed detected. The rotational speed can be the rotational speed of the at least one blade and/or the blade head around the axis of rotation. The rotational speed can be the rotational speed of a drive device for driving the at least one blade and/or the blade head in rotation about the axis of rotation. The target rotational speed can or will be specified for the drive device. The target rotational speed can or will be entered by an operator, for example. The target rotational speed can be entered as an initial input, for example. The target rotational speed can or will be entered as the initial target rotational speed, for example by an operator.

The rotational speed specified as the target value, such as the target rotational speed, can or will be calculated. The calculation of the rotational speed specified as the target value, such as the target rotational speed, can be based on a throughput value, such as a material throughput value, and/or a number of granules and/or a correction factor and/or a number of blades and/or a number of holes in the perforated plate. The throughput value can define a throughput of the granulated material. The throughput value can be a throughput of kilograms per hour. The throughput value can be a current and/or detected throughput, for example by sensors. The throughput value can or will be entered by an operator, for example. The number of granules can define or be the number of granules and/or pellets per gram. In addition or as an alternative to the number of granules, the mass of a defined number of granules and/or pellets can be used, in particular to calculate the rotational speed specified as the target value. The number of granules can be a number of pellets. The number of granules can or will be entered by an operator, for example. The number of granules can or will be identified empirically. The number of granules can be a current and/or detected number of granules, for example by sensors. The number of granules can be based on a previously carried out measurement. The number of blades can correspond to the number of blades arranged and/or installed on the blade head. The number of blades can or will be entered, for example by an operator. The number of holes can correspond to the number of holes in the perforated plate, in particular the holes from which the material to be granulated emerges. The number of holes can or will be entered, for example by an operator. The correction factor can or will be calculated and/or defined beforehand. The correction factor can or will be entered, for example by an operator. The correction factor can or will be stored, for example in a controller. The correction factor can depend on the number of open holes, such as drill holes, in the perforated plate.

When calculating the rotational speed specified as the target value, such as the target rotational speed, the product of the throughput value and the number of granules can or will be formed and/or calculated. When calculating the rotational speed specified as the target value, such as the target rotational speed, the product of the throughput value, the number of granules and the correction factor can or will be formed and/or calculated. When calculating the rotational speed specified as the target value, such as the target rotational speed, the product of the number of blades and the number of holes can or will be formed and/or calculated. When calculating the rotational speed specified as the target value, such as the target rotational speed, the product of the throughput value and the number of granules can or will be divided by the product of the number of blades and the number of holes, i.e., the division can or will be formed from both products. When calculating the rotational speed specified as the target value, such as the target rotational speed, the product of the throughput value, number of granules and correction factor can or will be divided by the product of the number of blades and number of holes, i.e., the division can or will be formed from both products.

The hydrodynamic force can or will be calculated and/or estimated and/or determined by means of a function, such as a polynomial function. The rotational speed, for example the rotational speed detected by sensors as an actual value, such as an actual rotational speed, can be the variable and/or indeterminate of the function. The function can be a function of the first, second, third, fourth or higher degree. The function can have one or more coefficients. The one or more coefficients can or will be defined by one or more parameters. Each coefficient can correspond to a parameter or be a parameter. The one or more parameters can or will be specified and/or identified, for example empirically identified. The one or more parameters can be based on at least one data series determined for at least one operating mode and/or process mode of the granulating machine. The one or more parameters can or will be determined from the at least one data series. The at least one data series can be an empirical, in particular empirically determined, data series. The at least one data series can or will be formed from mean values. The at least one data series can define and/or identify a trend curve and/or trend function. A trend curve and/or trend function can or will be identified from the at least one data series. The one or more parameters can or will be identified or determined from the trend curve and/or trend function. A plurality of data series can or will be detected in the same and/or different operating modes and/or process modes, in particular of the granulating machine. The one or more parameters can or will be determined from the plurality of data series.

The calculation of the pressing force and/or pressure, such as a contact pressure and/or a hydraulic pressure and/or a forward pressure, can be based on the fact that the blade pressing force is the sum of the pressing force, such as a hydraulic force, and the hydrodynamic force. The blade pressing force can be the sum of all forces acting on the blade head. The pressing force or the pressure, such as a contact pressure and/or a hydraulic pressure and/or a forward pressure, can be defined and/or calculated by resolving or converting this formula accordingly. The pressing force, such as a hydraulic force, can or will be based on or defined by the hydraulic parameters and/or calculated by means thereof. The pressing force, such as hydraulic force, can or will be based on or defined by the pressure, such as a contact pressure and/or a hydraulic pressure and/or a forward pressure, the first surface assigned to this pressure, the backward pressure and/or the second surface assigned to the backward pressure and/or can or will be calculated by means thereof. The pressing force, such as hydraulic force, can or will be defined by the product of the pressure, such as a contact pressure and/or a hydraulic pressure and/or a forward pressure, and the first surface assigned to this pressure, and/or can or will be defined by the product of the backward pressure of the second surface assigned to the backward pressure. The pressing force, such as hydraulic force, can or will be defined by the difference between or from the product of the pressure, such as a contact pressure and/or a hydraulic pressure and/or a forward pressure, and the first surface assigned to this pressure and the product of backward pressure and the second surface assigned to the backward pressure.

The pressing force can be determined on the basis of a hydrostatic force. The determination of the pressing force can be based on the specified blade pressing force, the determined hydrodynamic force and the hydrostatic force. The hydrostatic force can or will be specified. The hydrostatic force can or will be identified on the basis of, for example, a water pressure that is detected, such as by sensors, and/or a pressure surface that is, for example, specified. The pressure surface can or will be defined and/or calculated by a diameter, such as the seal diameter. The diameter can be a medium diameter, such as a medium seal diameter. The diameter can be the diameter, for example, in the region of a sliding ring and/or a seal, such as a sliding ring seal, and/or a gland packing, of a drive shaft of the drive device. The drive shaft can define the axis of rotation. The drive shaft can be non-rotatably connected to the blade head. When calculating the hydrostatic force, the product of the pressure surface and the water pressure can or will be formed. The pressure surface can be squared or raised to the power of 2. Thus, the product of the pressure surface squared and the water pressure can or will be formed. The product of the pressure surface squared and the water pressure can or will be multiplied by the value π/4.

The calculation of the pressing force and/or the pressure, such as a contact pressure and/or a hydraulic pressure and/or a forward pressure, can be based on the fact that the blade pressing force is the sum of the pressing force, such as hydraulic force, the hydrodynamic force and the hydrostatic force. The pressing force or the pressure, such as a contact pressure and/or a hydraulic pressure and/or a forward pressure, can be defined and/or calculated by resolving or converting this formula accordingly.

The pressing force can be determined on the basis of a melt pressure force. The determination of the pressing force and/or the pressure, such as a contact pressure and/or a hydraulic pressure and/or a forward pressure, can be based on the specified blade pressing force, the determined hydrodynamic force and the melt pressure force. The determination of the pressing force and/or the pressure, such as a contact pressure and/or a hydraulic pressure and/or a forward pressure, can be based on the specified blade pressing force, the determined hydrodynamic force, the hydrostatic force and the melt pressure force. The melt pressure force can be a function of a melt pressure of a material melt caused by an extrusion device and/or can or will be calculated by means of this.

The calculation of the pressing force and/or pressure, such as a contact pressure and/or a hydraulic pressure and/or a forward pressure, can be based on the fact that the blade pressing force is the sum of the pressing force, such as hydraulic force, the hydrodynamic force and the melt pressure force. The calculation of the pressing force and/or pressure, such as a contact pressure and/or a hydraulic pressure and/or a forward pressure, can be based on the fact that the blade pressing force is the sum of the hydraulic force, the hydrodynamic force, the hydrostatic force and the melt pressure force. The pressing force or the pressure, such as a contact pressure and/or a hydraulic pressure and/or a forward pressure, can be defined and/or calculated by resolving or converting this formula accordingly.

The calculation of the pressing force and/or the pressure, such as a contact pressure and/or a hydraulic pressure and/or a forward pressure, can be carried out automatically and/or repeatedly, for example during the operation of the granulating machine. For example, the pressing force and/or the pressure, such as a contact pressure and/or a hydraulic pressure and/or a forward pressure, can be calculated continuously and/or continually. The calculation can also be carried out and/or repeated at defined time intervals.

The method may comprise the step: Providing the calculated pressure, such as a contact pressure and/or a hydraulic pressure and/or a forward pressure, of the force generation device, such as a hydraulic device, for adapting the pressure, such as a contact pressure and/or a hydraulic pressure and/or a forward pressure, prevailing in the granulating machine and/or in the force generation device, such as a hydraulic device. The calculated pressure, such as a contact pressure and/or a hydraulic pressure and/or a forward pressure, of the force generation device, such as a hydraulic device, can be provided as, for example, a new target value, such as a target pressure, a target contact pressure, a target hydraulic pressure or a target forward pressure. The calculated pressure, such as a contact pressure and/or a hydraulic pressure and/or a forward pressure, of the force generation device, such as a hydraulic device, can be provided to the force generation device, such as a hydraulic device, as, for example, a forward pressure and/or a target value, such as a target forward pressure. As a result, the pressure, such as a contact pressure and/or a hydraulic pressure and/or a forward pressure, of the force generation device, such as a hydraulic device, can be adapted. The calculated pressure, such as a contact pressure and/or a hydraulic pressure and/or a forward pressure, of the force generation device, such as a hydraulic device, can be provided and/or adapted automatically and/or repeatedly and/or continually, for example during the operation of the granulating machine. For example, the calculated pressure, such as a contact pressure and/or a hydraulic pressure and/or a forward pressure, can be provided and/or adapted to the force generation device, such as a hydraulic device, continuously and/or continually. The provision and/or adaptation can also be carried out and/or repeated at defined time intervals.

The method, in particular for adapting the pressing force, can be stored and/or implemented at least partially as a computer program on a computer, microcomputer, in a controller, in an electronic control and/or computing unit, in a control and/or computing device or on a storage medium. The computer program can be distributed in terms of software to one or more storage media, controllers, control and/or computing units/devices or computers, etc.

A computer program product can cause a controller and/or an apparatus, such as a granulating machine, to execute the method described above and/or below, in particular for adapting the pressing force. A computer program product can comprise program code means in order to execute the method described above and/or below, in particular for adapting the pressing force, when the computer program product is executed on a processor. A computer program product can cause an apparatus, such as, for example, an electronic controller and/or a control and/or computing unit/device, a control system, a granulating machine, a granulator, such as an underwater granulator and/or underwater granulating machine, a processor or a computer, to execute the method described above and/or below, in particular for adapting the pressing force. For this purpose, the computer program product can have corresponding data records and/or program code means and/or the computer program and/or a storage medium for storing the data records or the program.

A controller, such as a control unit or control device, can be for a granulating machine, such as an underwater granulating machine. The controller can be configured and intended for use in a granulating machine. The controller can have a microcomputer and/or processor. The controller can comprise one or more sensors and/or be connected to them. The controller can comprise the computer program product described above and/or below. The controller can have a memory. The computer program product can be stored in the memory. The controller can be configured and/or intended to carry out the method described above and/or below, in particular for adapting the pressing force.

A granulating machine can be designed and/or intended for granulating material strands, such as plastic material strands. The granulating machine can be configured and/or intended to carry out the method described above and/or below, in particular for adapting the pressing force and/or for granulating material strands. The granulating machine can be designed and/or controlled and/or regulated as described above and/or below. The granulating machine can have the controller described above and/or below.

The granulating machine can be an underwater granulating machine. The granulating machine can have a perforated plate. The perforated plate can be used and/or designed to generate material strands. The granulating machine can have at least one blade. The at least one blade can be a granulating blade. The granulating machine can have a plurality of blades, such as granulating blades. The granulating machine can have a blade head. The blade head can have the at least one blade or the blades. The blade head can have at least one blade wing. The blade head can have a plurality of blade wings, for example a corresponding number of blade wings for the number of blades. The at least one blade or the blades can be connected, for example screwed, to the blade head and/or its blade wing. The at least one blade wing or the blade wings can be connected to a shaft, such as a drive shaft, of a drive device. The blade head can be used and/or designed to generate granules from the material strands. The blade head can be arranged on a downstream side of the perforated plate. The granulating machine can have a drive device. The drive device can be used and/or designed to drive the blade head in rotation about an axis of rotation. The drive device can have the shaft, such as the drive shaft. The shaft can define the axis of rotation. The axis of rotation can be arranged concentric or eccentric to the perforated plate. The granulating machine can have a granulating hood. The granulating hood can be one-piece, two-piece or multi-piece. The perforated plate and the blade head can or will be surrounded and/or at least partially or completely enclosed by the granulating hood. The granulating hood can or will be completely or partially filled with water. The granulating machine can have a water supply line, in particular one that opens into the granulating hood. The granulating machine can have a water-granule discharge line, in particular one that opens out of the granulating hood. The granulating machine can have a force generation device. The force generation device can be used and/or designed for pushing the at least one blade or blades against the perforated plate with the pressing force and/or contact pressure. The force generation device can be designed to move or displace the at least one blade or the blades, the blade head and/or the drive device, for example in the longitudinal direction of the granulating machine and/or in the forward and/or backward direction and/or in the direction of or along the axis of rotation. The force generation device can be designed and/or controlled and/or regulated as described above and/or below. The force generation device can be a hydraulic device, such as a hydraulic system, a pneumatic device, such as a pneumatic system, a hydro-pneumatic device, an electronic device, a mechanical device or an electro-mechanical device. The force generation device can have a drive, for example a hydraulic, pneumatic, hydro-pneumatic, electronic or electro-mechanical drive, such as a linear drive or a servo drive. The hydraulic device can be a hydraulic aggregate and/or a hydraulic pressure aggregate and/or a hydraulic pressure unit. The hydraulic device can have at least one piston. The at least one piston can be displaceably mounted in a cylinder. The at least one piston can be acted upon and/or displaced by means of a hydraulic fluid.

A method can or will be used to granulate material strands, such as plastic material strands. The method may comprise the step: Providing a granulating machine. The granulating machine can be designed and/or controlled and/or regulated as described above and/or below. The method can further comprise the step of: Conveying a material melt, such as a plastic material melt, through the perforated plate in such a way that material strands are generated. The method can further comprise the step of: Driving the blade head in rotation by means of the drive device in such a way that the material strands are cut into granules by means of the at least one blade. The hydraulic device can push the at least one blade or the blades against the perforated plate with the pressing force and/or contact pressure.

With embodiments of the disclosure, the pressing force and/or the contact pressure can be optimally set or regulated. Wear, for example on blades and perforated plates, can be reduced. This allows costs to be optimized and machine downtimes to be avoided. The granule quality can be improved.

In the following, exemplary embodiments of the disclosure are described in more detail with reference to figures, in which, schematically and by way of example:

FIG. 1 a flow chart for a method for adapting the pressing force;

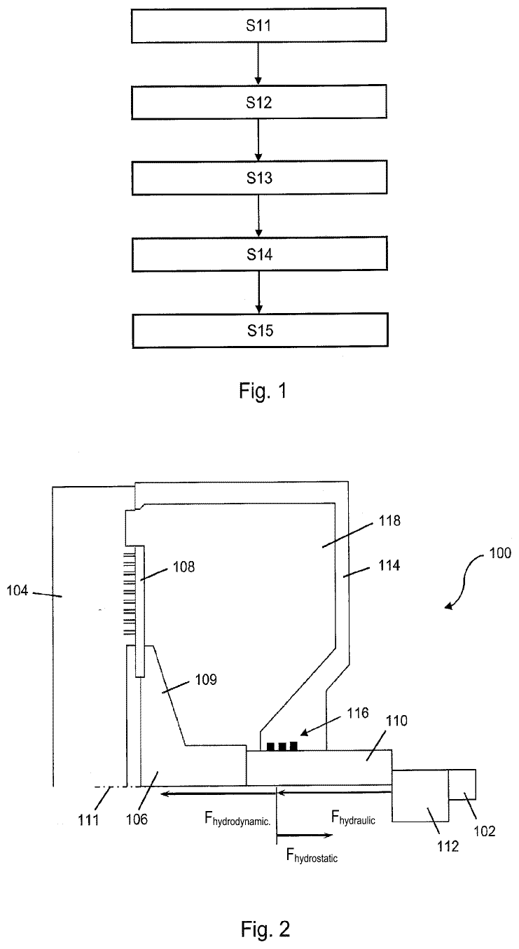

FIG. 2 a granulating machine with a controller; and

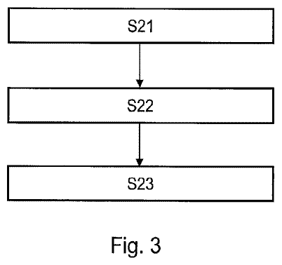

FIG. 3 a flow chart for a method for granulating material strands.

FIG. 1 schematically shows a flow chart for a method for adapting the pressing force of at least one blade, such as a granulating blade, of a granulating machine for granulating material strands, such as plastic material strands, wherein the granulating machine has a hydraulic device for pushing the at least one blade with the pressing force against a perforated plate of the granulating machine. The pressing force can be a hydraulic force, in particular from the hydraulic device.

In a step S11, a blade pressing force is specified as the target value. The blade pressing force depends on the properties and number of blades and on the properties of the material to be granulated.

In a step S12, at least one hydraulic parameter of the hydraulic device is provided. For example, three hydraulic parameters can be provided, such as a first surface assigned to a forward pressure, a backward pressure and a second surface assigned to the backward pressure.

In a step S13, a hydrodynamic force, such as axial compressive force, is determined, which is generated by rotation of the at least one blade and which acts on the at least one blade towards the perforated plate.

The hydrodynamic force is calculated on the basis of an actual rotational speed detected by sensors, in particular the blade speed and/or blade head speed, wherein a target rotational speed was previously specified. The actual rotational speed is thus regulated to a specified target rotational speed. The rotational speed specified as the target value is calculated on the basis of a throughput value, such as a material throughput value, a number of granules, a correction factor, a number of blades and a number of holes in the perforated plate.

The calculation of the hydrodynamic force is carried out by means of a function, such as a polynomial function, wherein the actual rotational speed is the variable and/or indeterminate of the function, the function is a second-degree function and the function has a plurality of, for example three, coefficients that are defined by a plurality of, for example three, parameters. The plurality of parameters can or will be predefined. For example, the plurality of parameters can have been previously identified empirically and they are based on at least one data series determined for at least one operating mode of the granulating machine.

In a step S14, the forward pressure of the hydraulic device is calculated on the basis of the specified blade pressing force, the provided at least one hydraulic parameter, for example the three hydraulic parameters, and the determined hydrodynamic force. The calculation of the forward pressure is based on the fact that the blade pressing force is the sum of the hydraulic force and the hydrodynamic force. The forward pressure can be defined and calculated by resolving or converting this formula accordingly. The calculated forward pressure is a target forward pressure of the hydraulic system.

In a step S15, the calculated forward pressure is provided, in particular as a new target value for the hydraulic device, for adapting the pressing force or contact pressure prevailing in the granulating machine. As a result, the forward pressure and thus the pressing force or contact pressure can be adapted. Through the repeated execution of the method, the forward pressure can be provided and adapted automatically and repeatedly during the operation of the granulating machine.

FIG. 2 schematically shows a granulating machine 100 for granulating material strands, such as plastic material strands, which is configured and intended to execute the method or methods described above and/or below, in particular according to FIGS. 1 and/or 3. For this purpose, the granulating machine 100 has a controller 102 with a processor and a corresponding computer program product.

The granulating machine 100 is designed as an underwater granulating machine and comprises a perforated plate 104 for generating material strands, a blade head 106 with at least one blade 108, which is arranged on a downstream side of the perforated plate 104 for generating granules from the material strands, a drive device with a rotating shaft 110 for driving the blade head 108 in rotation about an axis of rotation 111 and a hydraulic device 112 for pushing the at least one blade 108 with the pressing force or contact pressure against the perforated plate 104. The blade head 106 also has blade wings 109, to which the blades 108 are fastened. The blade wings 106 are firmly connected to the rotating shaft 110.

The granulating machine 100 also has a granulating hood 114, which encases the perforated plate 104 and the rotating shaft 110 at least in sections. A seal 116, for example a sliding ring seal 116, is effectively arranged between the granulating hood 114 and the rotating shaft 110. The granulating hood 114 defines or delimits a chamber 118 within which the blade head 106 with the blades 108 is arranged.

The arrows shown in FIG. 2 illustrate the hydrodynamic force F_{hydrodynamic}, the hydraulic force F_{hydraulic} and the hydrostatic force F_{hydrostatic}.

In addition, reference is made in particular to FIG. 1 and the associated description.

FIG. 3 shows a schematic diagram of a method for granulating material strands.

In a step S21, a granulating machine 100 is provided. The granulating machine 100 is designed as described above and/or below, in particular according to FIG. 2.

In a step S22, a material melt, such as a plastic material melt, is conveyed through the perforated plate 104 in such a way that material strands are generated.

In a step S23, the blade head 106 is rotationally driven by means of the drive device in such a way that the material strands are cut into granules by means of the at least one blade 108, wherein the hydraulic device 112 presses the at least one blade 108 against the perforated plate 104 with the pressing force or contact pressure.

In all other respects, reference is made in particular to FIGS. 1 and 2 and the associated description.

The term “may” refers in particular to optional features of embodiments of the disclosure. Accordingly, there are also developments and/or exemplary embodiments which additionally or alternatively have the respective feature or the respective features.

From the feature combinations disclosed in herein, isolated features may also be singled out as required and, by resolving an optionally existing structural and/or functional relationship between the features in combination with other features, be used to delimit the subject matter of the claim. The sequence and/or number of steps of the method can be varied. The methods can be combined with one another, for example to create an overall method.

### REFERENCE SIGNS

S11 Step for specifying a blade pressing force
S12 Step for providing hydraulic parameters
S13 Step for determining a hydrodynamic force
S14 Step for calculating the forward pressure
S15 Step for providing the calculated forward pressure
100 Granulating machine
102 Controller
104 Perforated plate
106 Blade head
108 Blade
109 Blade wing
110 Rotating shaft
111 Axis of rotation
112 Hydraulic device
114 Granulating hood
116 Sliding ring seal
118 Chamber
F_{hydrodynamic} Hydrodynamic force
F_{hydraulic} Hydraulic power
F_{hydrostatic} Hydrostatic force
S21 Step for providing a granulating machine
S22 Step for conveying a material melt and generating the material strands
S23 Step for driving the blade head in rotation and pushing the blades against the perforated plate with the contact pressure

1. A method for adapting a pressing force of at least one blade of a granulating machine for granulating material strands, wherein the granulating machine has a force generating means for pushing the at least one blade with the pressing force against a perforated plate of the granulating machine, said method comprising the steps of:
Specifying a blade pressing force;
Determining a hydrodynamic force which is generated by rotation of the at least one blade and acts on the at least one blade towards the perforated plate;
Determining the pressing force on the basis of the specified blade pressing force and the determined hydrodynamic force; and
Providing the determined pressing force to adapt the pressing force prevailing in the granulating machine.

2. The method according to claim 1, wherein the blade pressing force is specified as a target value, which is a function in particular of the properties and/or number of blades and/or on the properties of the material to be granulated.

3. The method according to claim 1, wherein the force generation device is a hydraulic device, a pneumatic device, a hydro-pneumatic device, an electronic device, a mechanical device or an electro-mechanical device and/or the force generation device is designed to generate and/or provide the pressing force.

4. The method according to claim 1, wherein the force generation device has a hydraulic drive, a pneumatic drive, a hydro-pneumatic drive, an electronic drive or an electro-mechanical drive.

5. The method according to claim 1, wherein the pressing force is a contact pressure force and/or a hydraulic force, and/or the pressing force is the difference between an axial forward force and an axial backward force.

6. The method according to claim 1, wherein at least one parameter of the force generation device is provided, and/or in that a pressure is calculated on the basis of the provided and/or determined pressing force and/or the provided at least one parameter of the force generation device.

7. The method according to claim 6, wherein the calculated pressure is provided for adapting the pressure prevailing in the granulating machine as a new target value.

8. The method according to claim 6, wherein the calculated pressure is an axial forward pressure of the hydraulic device, and/or in that the at least one parameter is a first surface assigned to the calculated pressure of the hydraulic device, and/or is an axial backward pressure of the hydraulic device, and/or is a second surface of the hydraulic device, which is assigned to the axial backward pressure.

9. The method according to claim 8, wherein a forward pressure is calculated on the basis of the first surface assigned to the pressure and/or the axial backward pressure and/or the second surface assigned to the axial backward pressure.

10. The method claim 8, wherein the axial backward pressure is detected by sensors and/or the first surface assigned to the calculated pressure, and/or the second surface assigned to the axial backward pressure are or will be specified.

11. The method according to claim 1, wherein the hydrodynamic force is calculated or detected by sensors.

12. The method according to claim 1, wherein the hydrodynamic force is calculated and/or estimated and/or determined on the basis of a blade rotational speed and/or a blade head rotational speed.

13. The method according to claim 12, wherein an actual value of the blade rotational speed and/or the blade head rotational speed is detected by sensors and/or a rotational speed is specified as a target value.

14. The method according to claim 13, wherein the rotational speed specified as the target value is calculated on the basis of a throughput value, and/or a number of granules and/or a correction factor and/or a number of blades and/or a number of holes in the perforated plate.

15. The method according to claim 11, wherein the hydrodynamic force is calculated and/or estimated and/or determined by means of a function, wherein a rotational speed detected by sensors as an actual value is the variable and/or indeterminate of the function and/or the function is a function of first, second, third, fourth or higher degree and/or the function has one or more coefficients that are defined by one or more parameters.

16. The method according to claim 15, wherein the one or more parameters are or will be specified and/or identified, and/or the one or more parameters are based on at least one data series determined for at least one operating mode of the granulating machine.

17. The method according to claim 1, wherein the pressing force is determined on the basis of a hydrostatic force, wherein the hydrostatic force is or will be specified and/or wherein the hydrostatic force is or will be identified on the basis of a water pressure that is detected, and/or a pressure surface.

18. The method according to claim 1, wherein the pressing force is determined on the basis of a melt pressure force that is a function of a melt pressure of a material melt caused by means of an extrusion device.

19. A computer program product, which causes a controller and/or an apparatus, such as a granulating machine, to execute a method according to claim 1.

20. A controller for a granulating machine, wherein the controller is configured and intended to execute a method according to claim 1.

21. A granulating machine for granulating material strands, such as plastic material strands, which is configured and intended to execute a method according to claim 1.

22. The granulating machine according to claim 21, comprising:
a perforated plate for generating material strands;
a blade head with at least one blade, which is arranged on a downstream side of the perforated plate for generating granules from the material strands;
a drive device for driving the blade head in rotation about an axis of rotation; and
a hydraulic device, for pushing the at least one blade with a pressing force and/or a contact pressure against the perforated plate.

23. A method for granulating material strands, such as plastic material strands, said method comprising the steps of:
Providing a granulating machine according to claim 21;
Conveying a material melt through the perforated plate in such a way that material strands are generated; and
Driving the blade head in rotation by means of the drive device in such a way that the material strands are cut into granules by means of the at least one blade, wherein the hydraulic device presses the at least one blade against the perforated plate with the pressing force and/or the contact pressure.
